(19) United States
(12) Patent Application Publication
(10) Pub. No.: US 2006/0150007 A1
(43) Pub. Date: Jul. 6, 2006

(54) Parallel processing platform with synchronous system halt/resume

(76) Inventors: Victor Gostynski, Ashdod (IL); Shaul Dorf, Ashdod (IL)

Correspondence Address: PEARL COHEN ZEDEK, LLP, 1500 BROADWAY 12TH FLOOR, NEW YORK, NY, 10036, US

(21) Appl. No.: 10/524,501

(22) PCT Filed: Aug. 12, 2003
(86) PCT No.: PCT/IL03/00671

§ 371 Date: Sep. 29, 2005

(30) Foreign Application Priority Data
Aug. 14, 2002 (IL) 151251

(51) Int. Cl. G06F 11/00

(52) U.S. Cl. 714/12

(57) ABSTRACT

A method for synchronous debugging of a parallel processing platform, the platform comprising a plurality of processors executing code, the code including one or more breakpoints to allow debugging of the code. The method comprises upon a processor reaching a breakpoint, propagating a halt command to all of the processors in the platform; thereby halting system execution synchronously to enable examination of the states of the processors.

### FIELD OF THE INVENTION

The present invention relates to a parallel processing platform that enables synchronous system halt/resume for debugging and other purposes.

### BACKGROUND OF THE INVENTION

Software development is largely an art. Specifications for an application and a system that is to be implemented by software are usually written in a human language such as English. These specifications are interpreted by a human programmer who writes machine interpretable statements, in a “language” such as ‘C’, that implements the behavior specified. The statements, usually referred to as the “source code”, are converted by a series of automatic tools into a binary executable program. This executable code can then be invoked to run on the intended computing platform.

The source code created at this step is rarely, if ever, without mistakes and problems, referred to as “bugs” in the programming parlance. The specifications might be unclear or ambiguous, the interpretation might be wrong, and mistakes are practically unavoidable. The programmer must therefore test his/her executable code to verify that it is in fact performing as specified under actual inputs stimulus. Often it will be obvious that the code is not performing as intended since the behavior will be erratic and/or the output not as expected. Unfortunately in most cases it is far from obvious why things went wrong and what statement(s) in the programmer's source code must be corrected and how. At this point the programmer starts to “debug” his/her source code in order to find out just that.

A widely used tool for detecting program errors is the interactive debugger. With this tool, the programmer executes the code he/she generated in a controlled way, stepping through the execution of the code and stopping at key points to examine the “state” of the system and to see what branches were taken at conditional junctions in the code. The state comprises of the value of variables and structures, processors registers, registers of input/output controllers and other data.

A key feature of the interactive debugger is “breakpoints”. A breakpoint is a trap placed by the programmer at one or more points in the executable code. More specifically, a breakpoint is a set of conditions that when fully satisfied halt the execution of the system, thus freezing its state. Conditions can be as simple as executing a particular instruction in the code or accessing a range of memory locations. Conditions may be nested, such as breaking only after N executions of an instruction or after meeting a particular sequence of conditions.

Usually multiple breakpoints are set and active at any given time during program execution, setting up a plurality of “traps” that the executing program can trip on. The identity of which breakpoint of the many that are set tripped and halted the execution is by itself a strong clue to a problem. Once the execution of the program trips on one of these breakpoints, the computer stops executing the code and transfers the control to the programmer.

It should be noted that the whole purpose of the breakpoint and the debugger is to freeze the state of the platform at the time of the break. A frozen state enables the programmer to see which branches the program took (based on which breakpoint caused the break) and to see what transpired just prior to the break by examining memory locations and registers.

Many times everything looks fine and no malfunction manifests itself. In such situations it is very convenient and time saving to restart the execution of the system under test from the exact point and from the same state that existed at the time of the break. Once restarted, another breakpoint is encountered, and so forth. At every break the programmer can remove some or all of the existing breakpoints and/or set others.

Even if a malfunction is detected, a programmer will sometimes find it more convenient to make a temporary fix and continue debugging rather than go through the time consuming and tedious cycle of source-code edit—compile—link—and back to debug.

Many computing applications, in particular those that are real-time and embedded, cannot be implemented by a single processor, be it the most powerful one available. Many can, however, be implemented by employing multiple communicating processors in parallel, dividing the computing task among these processors. Many vendors offer such platforms based on any of a number of architectures. These platforms, referred to as parallel processing platforms, have a wide range of scalability, bringing from as little as two to as many as thousands or more processors to bear on a problem.

However, all these processors cannot work in isolation. They must exchange information among themselves. Therefore, any given processor is influenced and controlled by inputs from other processors in the system, directly or indirectly, and similarly influences the behavior of others.

Testing that many processors with such complex input interactions brings a whole new dimension to the debugging process. In particular, it becomes highly desirable to enable the whole set of processors to halt simultaneously when any one of them encounters a breakpoint.

Although a malfunction might manifest itself when a particular breakpoint is reached, the real culprit might be an event generated prior to the breakpoint, perhaps in a different processor. It is therefore important to be able to examine not only the state of the processor stopped by the breakpoint but also the state of all the other processors. If the others are not halted immediately, their states change in a matter of nanoseconds or less, in which case it may no longer be possible to determine the cause of the malfunction from the contents of their memory and registers.

No less important is restarting the whole set of processors from the same coherent state. Losing the state of the other processors will usually require restarting the debugging session from the beginning after each breakpoint. This may be very tedious and time consuming and frequently will even be impractical.

There is more than one way to trace the execution of the program in order to find where things started to go wrong, see for example, the system described in U.S. Pat. No. 6,031,991 by Hirayama. There a debugging system is used in a multiprocessor system for executing a plurality of programs on multiple processors while taking checkpoints. On an error, the system shifts to a debug mode and restarts the programs from a checkpoint taken immediately before the error occurred. This however has two disadvantages: The first is that all the history prior to the restored checkpoint is not available anymore. The erratic behavior of the system under test might emanate from erroneous code executed prior to the restored checkpoint. The second disadvantage is that when a bug is encountered after restarting from a checkpoint but the other processors are not stopped, the state of all of these is again lost and cannot provide clues to the actual bug.

Another example is disclosed in U.S. Pat. No. 5,602,729 by Krueger et al. There, the operation of the multi-processor is not halted (i.e., no breakpoints are used) but signals are used as indications about the operation of functional units and their characteristics. The signals are the input to a monitor used by the person doing the system debugging. This however requires substantially larger and more expensive resources.

Yet another example is disclosed in U.S. Pat. No. 5,642,478 by Chin-Huang Chen et al. According to this invention, rather than to break the execution and examine the state of the platform “on-line” (as described above), a time-ordered “trace” of the execution of the plurality of software processes executing on a plurality of hardware processors is logged to an external device. This log is then examined off-line by the programmer to find erratic behavior. The person that does the debugging of the system must therefore plan an experiment ahead of time and “seed” the software under test with event logging commands, as he/she would seed it by breakpoints. The disadvantage of this approach to on-line debugging is that if the planned experiment was not anticipating a particular bug, a new experiment is most probably required to be planned, executed and its results examined. In the on-line breakpoint approach however, the debugging is interactive and the person doing it can change course, reset all or part of the present breakpoints, and set others according to the newly discovered information.

It is therefore an object of the present invention to provide a parallel processor platform that enables interactive debugging.

It is a further object of the present invention to add and embed hardware support for a debugging program that enables a synchronous halt of all the processors when a breakpoint is encountered by any single processor and enables a synchronous restart thereafter.

It is another object of the present invention to enable synchronous halt/resume through a combination of software and hardware means.

These and other objects of the invention are evident in the drawings and description that follow.

### BRIEF DESCRIPTION OF THE INVENTION

<TBD>

### DESCRIPTION OF THE FIGURES

The invention is described herein, by way of example only, with reference to the accompanying Figures, in which like components are designated by like reference numerals.

FIG. 1 is a general block diagram of parallel processing hardware with synchronous system halt/resume in accordance with a preferred embodiment of the present invention.

FIG. 2 is a diagram of a typical hardware implementation of parallel processing hardware with synchronous system halt/resume in accordance with a preferred embodiment of the present invention.

FIG. 3 is a flowchart of the action taken by the first processor to encounter a breakpoint in the parallel computing platform.

FIG. 4 is a flowchart of the process that occurs in all the processors of the parallel computing platform as a result of the breakpoint/resume interrupt.

### DETAILED DESCRIPTION OF THE INVENTION

The present invention is a system and method for providing improved interactive debugging of a parallel processing platform by enabling a synchronous halt when a breakpoint is encountered and enabling a synchronous restart thereafter.

The most common way to implement a breakpoint on a given computer instruction is to use a debugger application to “insert a breakpoint” by replacing the instruction with a “branch” instruction to the debugger's own breakpoint handling code. The branch effectively seizes control from the application-under-test (hereafter referred to as AUT) and passes it back to the debugger.

In a single-processor platform, the debugger, invoked by such a branch instruction, freezes the state of the AUT since, by definition, there is only the one processor in the system. This is not the case in a parallel processing platform.

In the parallel platform when a processor reaches a breakpoint, it is necessary to add a further step of explicitly freezing the state of all of the processors in the platform. Once the processors have been stopped, the programmer can examine the state of any or all of them. He/she can then restart the processors from exactly the point where they left off.

Accordingly, in the present invention the parallel platform hardware is adapted to enable the debugger to freeze the states of the all of the processors in the platform when one of the processors reaches a breakpoint. This provides the programmer with the ability to examine he processor states and to restart them from the point where they left off when the system was stopped.

The invention can be implemented in many ways, according to the software and hardware characteristics of the processors chosen for the platform. One method of implementation that will work for most, if not all platforms is, when a processor reaches a breakpoint, it executes a system I/O-write call in the debugger's breakpoint handling routine to trigger a processor's hardware I/O signal, and then to propagate this I/O signal as an interrupt to all the processors across the platform.

The system and method of the present invention will become clearer and better appreciated with reference to the accompanying figures.

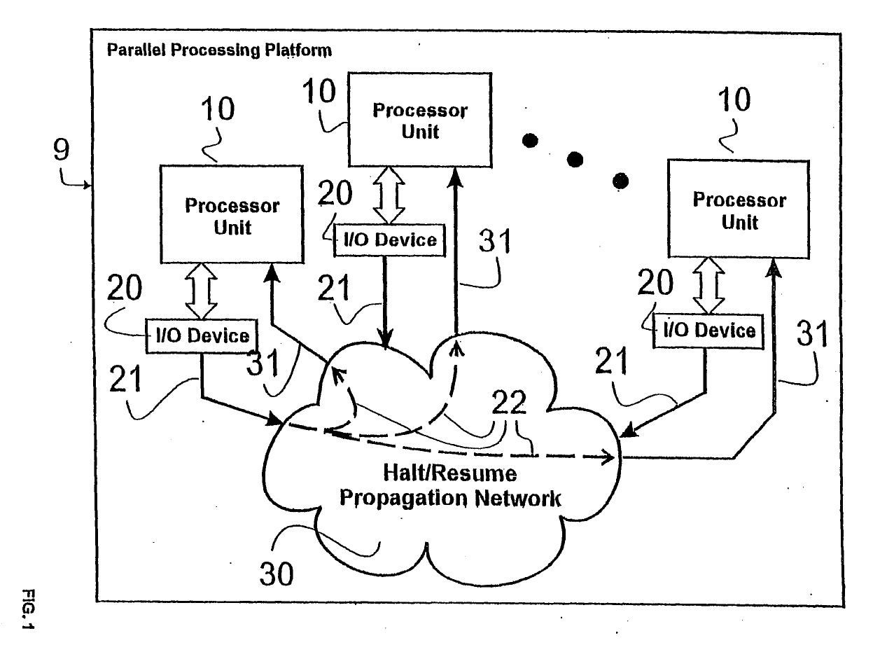

### FIG. 1—PREFERRED EMBODIMENT

Reference is now made to FIG. 1, which is a general block diagram of a preferred embodiment of the present invention. The parallel processing platform 9 (hereafter “platform”) comprises a plurality of processors 10. Each processor 10 is connected to an instance of hardware I/O device 20. Each hardware I/O device 20 has an output signal pin 21. Both the processor 10 and the hardware I/O device 20 are connected via signal pin 21 to the hardware halt/resume propagation network (HRPN) 30. The HRPN 30 drives an interrupt pin on each and every processor 10 in platform 9.

### OPERATION OF PREFERRED EMBODIMENT—FIG. 1

During a debugging session breakpoints are inserted into the AUT (application-under-test) executable code on one or more of the processors 10. AUT execution is initiated and when any of the processors 10 reaches a breakpoint, the breakpoint handling routine writes to the I/O device 20, thereby activating output signal pin 21 of the hardware I/O device 20. The breakpoint signal is propagated, as shown by dashed lines 22, from output signal pin 21 to all the processors in platform 9 by the halt/resume propagation network 30. Propagation is effected by interrupt signals 31 to the interrupt pins of all processor units 10, including the processor that first encountered the breakpoint and asserted its signal 21 in the first place.

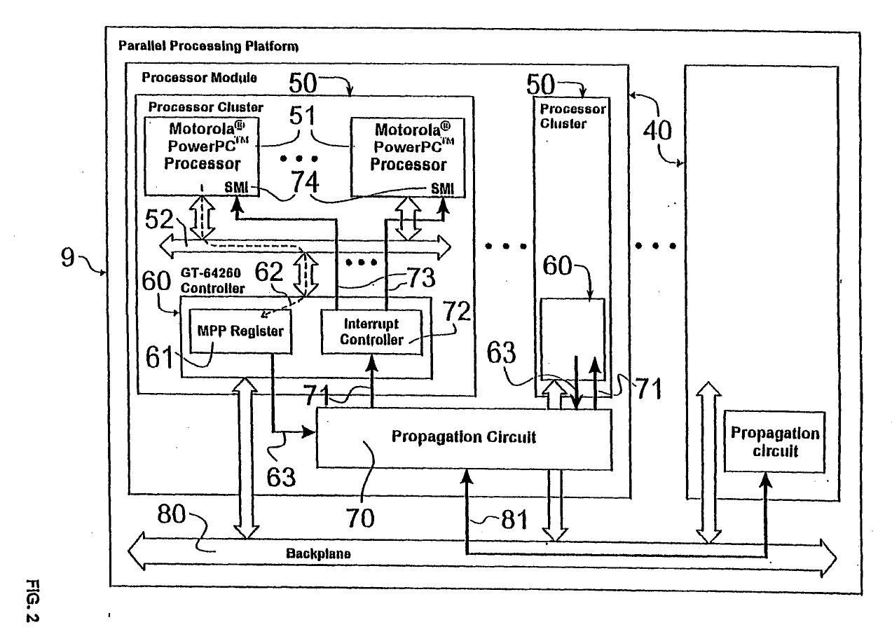

### FIG. 2—ALTERNATIVE EMBODIMENT

Reference is now made to FIG. 2, which is one possible hardware implementation among many in accordance with a preferred embodiment of the present invention. In this particular case, platform 9 is structured in a hierarchy comprising one or more parallel modules 40, each comprising one or more clusters 50, the clusters comprising two or more Motorola (R) Corporation PowerPC (TM processors 51. Each cluster 50 is controlled by a Galileo Technology Corporation GT-64260 system controller integrated circuit 60. System controller 60 includes many subsystems, of which two are relevant to this embodiment. These subsystems are the MPP register 61, which is an implementation of the I/O device 20 of FIG. 1 and the interrupt controller 72, which is an assumed part of the generic processor 10 of FIG. 1.

It should be noted that when a parallel platform is implemented using a different processor and/or a different support circuitry (usually referred to in the industry as “chipset”), other functions are often available in that chipset that could be used to implement the generation and propagation of the halt/resume interrupt. Any such implementation would fall within the definition of the present invention. The description of the preferred embodiment merely illustrates how the invention could be implemented given the particular characteristics of this particular chipset.

One of the MPP register 61 output pins serves as the halt/resume command signal 63. All the command signals 63 in a module 40 are connected to the module's propagation circuit 70. The propagation circuit 70 is an OR-gate driver replicating an asserted signal at any one of its inputs to all of its outputs. The propagation circuits 70 in all modules 40 are connected via a dedicated signal 81, part of the general purpose backplane bus 80.

Each module's 40 propagation circuit 70 is connected to interrupt controller 72 on cluster 50. Interrupt controller 72 is part of GT-64260 cluster controller 60. The system management interrupt (SMI) pin 74 of each of the PowerPC processors 51 is driven by an interrupt controller 72 output signal pin 73.

The combination of all the modules' propagation circuits 70, all the modules' interrupt controllers 72, and the backplane signal 81 that connect all of them together is the complete HRPN 30 implementation of FIG. 1. When reference is made to the HRPN, this combination is assumed.

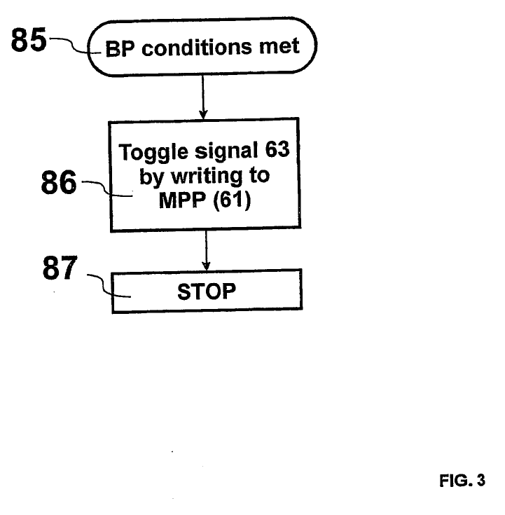

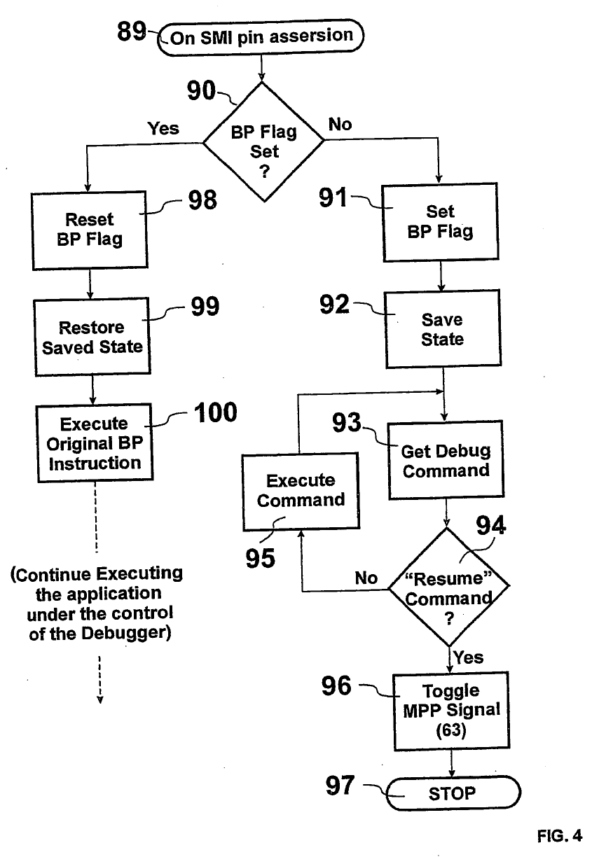

### FIG. 2, FIG. 3, AND FIG. 4—OPERATION OF ALTERNATIVE EMBODIMENT

Reference is again made to FIG. 2, which is one possible hardware implementation among many in accordance with a preferred embodiment of the present invention.

PowerPC processors 51 work in cooperation with one another, executing the same or different AUT code, to solve a computational problem. At least some of the AUT code in some of the PowerPC processors 51 has one or more breakpoints inserted in it for a debugging session.

Reference is made to FIG. 2 and FIG. 3 to describe the breakpoint handling routine. When a PowerPC processor 51 reaches a breakpoint (step 85), the routine writes (shown as dashed line 62) via standard I/O bus 52 to MPP register 61 (part of the GT-64260 cluster controller 60), thereby activating output Halt/Resume command signal 63 (summarized in step 86). The processor then stops further execution, step 87. It effectively waits for the interrupt it just generated to take effect and cause all processors 51, including this one, to execute the series of steps shown in FIG. 4. The signal is propagated via HRPN 30 to all SMI input pins 74 on the PowerPC processors 51 in the platform 9.

The HRPN 30 in the sample implementation is now described. The module's 50 propagation circuit 70 generates an interrupt signal 71 at the interrupt controller 72 input on each cluster 50. Interrupt controller 72 is part of GT-64260 cluster controller 60. Interrupt controller 72 in turn asserts its output signals 73 connected to the SMI signal pins 74 on each PowerPC processor 51 in cluster 50. Parallel elements in the module's propagation circuit 70 also assert a user-defined backplane signal 81 that distributes the breakpoint among all modules 40 in the platform 9. The operation of backplane signal 81 is identical to the operation of each and every halt/resume command signal 63 and is propagated by circuits 70 to all of their corresponding interrupt controllers 72 in each of clusters 50 in module 40.

In this fashion the breakpoint propagates across the parallel platform 9, almost simultaneously interrupting all processors 51 in the platform 9, which may number in the thousands or more.

The same means, method and implementation that propagate the breakpoint in a synchronous halt are also used for the synchronous resume. If and when the programmer decides at some point to resume the platform execution from the breakpoint, the resumption command is propagated across the platform 9 using the same I/O device and signal, propagation hardware, interrupt controller and interrupt signals, causing all of the processors to rerun the SMI handling software, but this time executing, almost simultaneously, the “resume” function.

The breakpoint interrupt handling software, invoked when the SMI pin 74 is asserted, is therefore invoked at both the synchronous halt and synchronous resume events. The operation of this software is depicted in the flowchart in FIG. 4. When the SMI pin 74 of a PowerPC processor is asserted by the Interrupt Controller output signal 73, the SMI handling procedure in FIG. 4 is invoked, starting at step 89.

The operation flow (namely whether it takes the Halt execution path 91 to 97 inclusive, as opposed to the Resume execution path, 98 to 100 inclusive) is dictated by the state of an internal breakpoint flag (hereafter referred to as “BP flag”) logical variable. When the BP flag is reset, the software executes the steps for a synchronous halt event. When the BP flag is set, the software executes the steps for a synchronous resume. The BP flag is initially reset. Conditional branch 90, which is executed first after step 89 branches to either of these execution paths.

The synchronous halt branch consists of steps 91 to 97. The first step 91 is to set the BP flag. (This is done so that on the next interrupt, which will be a synchronous resume, the procedure will take the other branch—the synchronous resume path of 97 to 100.)

In the next step 92, the internal state of the interrupted program is saved in an internal buffer. Like step 91, this step is in anticipation of the synchronous resume that might follow.

The loop comprised of step 93, the “no” branch of step 94 and step 95 is the conventional interactive debugger. As in any debugger, parallel or single, the programmer examines registers, memory locations and other state variables to see what transpired just prior to the breakpoint. Here however he/she can do so in any of the parallel processors since all are in the “halt” state.

If the programmer decides to resume AUT execution, he/she issues the “resume” command. This will make the debugger take the “yes” branch of 94 and to toggle the MPP register output Halt/Resume command signal 63. This is identical to the operations executed by the processor that encountered a breakpoint as depicted in FIG. 3, invoking the same SMI handling software as before. This time however, since the BP Flag is set, the conditional branch 90 will lead to the Resume path, steps 98 to 100. The first step here (98) is to reset the BP flag, priming the system for its next encounter with a breakpoint. The second step 99 is to load back the complete state of the interrupted process as it was at the time of the break. The last step 100 restores and executes the instruction on which a breakpoint was set, resuming the execution of the AUT from exactly the point that it was halted.

The behavior of the SMI handling routine described herein is only given as an example of one possible embodiment of the method. One skilled in the art could devise other ways to implement the same behavior.

It should be noted that the primary idea of the present invention is near-simultaneous propagation of the stopping command from a given processor to the rest of the processors in a parallel processing platform. The hierarchical breakpoint distribution network described above achieves this by making the delay from writing into the MPP register 61 to the assertion of the SMI pin 74 by interrupt controller output signal 73 nearly equal for all processors 51 across all the clusters 50 and modules 40. Propagation speed is further increased by choosing the high priority SMI as the service interrupt and by disabling any interrupt masks.

It should be further noted that how the principles of the present invention are implemented depends on the hardware characteristics of the parallel processing platform. FIG. 2 shows a typical implementation, using breakpoint handling routines and interrupts to implement the invention's primary purpose of propagating a breakpoint from one processor to the rest of the processors in the parallel processing platform. One skilled in the art can implement the concept in other ways, depending on the hardware characteristics of the processors and system controllers comprising the parallel processing platform.

It should be clear that the description of the embodiments and attached Figures set forth in this specification serves only for a better understanding of the invention, without limiting its scope as covered by the following Claims.

It should also be clear that a person skilled in the art, after reading the present specification could make adjustments or amendments to the attached Figures and above described embodiments that would still be covered by the following Claims.

1. A method for synchronous debugging of a parallel processing platform, the platform comprising a plurality of processors executing code, the code including one or more breakpoints to allow debugging of the code, the method comprising:
upon a processor reaching a breakpoint, propagating a halt command to all of the processors in the platform;
thereby halting system execution synchronously to enable examination of the states of the processors.

2. The method of claim 1 further including, upon receipt of a resume command, propagating the resume command to all the processors in the platform thereby enabling synchronous restart of the execution of the code by the processors.

3. The method of claim 1 wherein the propagating of the halt command to all of the processors in the platform comprises:
a. the processor that reached the breakpoint generating an interrupt output signal to a hardware I/O device;
b. the hardware I/O device propagating the interrupt output signal to all the processors in the platform.

4. The method of claim 1 wherein the processors are grouped in clusters, with each cluster including an interrupt controller and a register, the clusters are grouped in modules, with each module including an OR gate driver, the OR gate drivers are connected via a platform backplane, and wherein the propagating of the halt command to all of the processors in the platform comprises:
a. the processor that reached the breakpoint generating an output signal to the register of its cluster;
b. the register generating an output command signal to the OR gate driver of its module;
c. the OR gate driver generating an output command signal via the backplane to the other OR gate drivers in the platform;
d. each OR gate driver generating an output command signal to the interrupt controller of each cluster in the OR gate driver's module;
e. each interrupt controller of each cluster generating an output signal to an interrupt pin on each processor in the cluster;
thereby causing the processors to halt execution.

5. A parallel processing system for synchronous debugging of a parallel processing platform, the platform comprising a plurality of processors executing code, the code including one or more breakpoints to allow debugging of the code, the system comprising:
electrical circuitry for propagating, upon a processor in the platform reaching a breakpoint, a halt signal to all the processors in the system;
thereby halting system execution synchronously to enable examination of the states of the processors.

6. The system of claim 5 wherein said electrical circuitry upon receiving a resume command, propagates the resume command to all the processors in the system, thereby resuming system execution synchronously.

7. The system of claim 5, wherein the electrical circuitry for propagation comprises:
a. each processor being connected to a hardware I/O device;
b. each hardware I/O device including an output signal pin;
c. each output signal pin connected via OR gate drivers to interrupt pins on every processor in the system.

8. The system of claim 5, the processors grouped into one or more clusters, the clusters grouped into one or more modules, each module including an OR gate driver, the OR gate drivers connected via a platform backplane, the electrical circuitry for propagation comprising a system controller per cluster; the system controller comprising a register and an interrupt controller; the register including a halt/resume command signal output pin; the command signal output pins of all the registers in a module connected to the module's OR gate driver; the OR-gate driver replicating a command signal at any of its inputs to its outputs; the OR-gate driver having outputs to the other OR-gates in the platform and to the interrupt controller on each cluster in the OR gate driver's module; each interrupt controller having an output connected to an interrupt pin on each processor in the interrupt controller's cluster.
